(19) United States
(12) Patent Application Publication
(10) Pub. No.: US 2012/0136169 A1
(43) Pub. Date: May 31, 2012

(54) POLYOLS MADE FROM PARTIALLY-EPOXIDIZED, FULLY-HYDROGENATED FATTY ACID ALKYL ESTERS

(75) Inventors: Timothy Walter Abraham, Minnetonka, MN (US); Wei Zhang, Eden Prairie, MN (US)

(73) Assignee: CARGILL, INCORPORATED, Wayzata, MN (US)

(21) Appl. No.: 13/262,163

(22) PCT Filed: Mar. 23, 2010
(86) PCT No.: PCT/US2010/028329

§ 371 Date: Dec. 19, 2011

Related U.S. Application Data
(60) Provisional application No. 61/165,322, filed on Mar. 31, 2009.

(51) Int. Cl. C08G 63/78; C08G 63/82

(52) U.S. Cl. 560/182

(57) ABSTRACT

A method is described for producing polyester polyols by partially-epoxidizing fatty acid alkyl esters having an iodine value from 90 to 190 g I2/100 grams, fully-hydrogenating the partially-epoxidized esters to form hydroxylated fatty acid alkyl esters, and then reacting the hydroxylated fatty acid alkyl esters with a multifunctional ester-reactive initiator compound to form the polyester polyol.

### CROSS REFERENCE TO RELATED APPLICATION

This application claims the benefit of U.S. provisional application Ser. No. 61/165,322 filed Mar. 31, 2009 entitled POLYOLS MADE FROM PARTIALLY-EPOXIDIZED, FULLY-HYDROGENATED FATTY ACID ALKYL ESTERS, which is hereby incorporated by reference.

### FIELD

The present invention relates to polyester polyols that are made by partially epoxidizing unsaturated fatty acid alkyl esters, then fully hydrogenating the partially epoxidized fatty acid alkyl esters to hydroxylated fatty acid alkyl esters, and polymerizing the hydroxylated fatty acid alkyl esters.

### BACKGROUND

Polyols are generally produced from petroleum-derived feedstocks. Polyols have been used in a variety of applications, including coatings, adhesives, sealants, elastomers, resins, and foams. Polyurethane foams are a particularly large end-use market where polyols are used.

Recently, non-petroleum based polyols have become available. These non-petroleum based polyols can be produced from vegetable oils.

Some examples of non-petroleum based polyols include those described in U.S. Pat. Nos. 6,107,433, 6,433,121, 6,573,354, and 6,686,435 as well as PCT Publications WO 2006/012344 A1 and WO 2006/116456 A1.

U.S. patent application Ser. No. 11/165,962 discloses the partial and full epoxidation of the carbon-carbon double bonds in a natural oil followed by ring opening the epoxy groups with a ring opener, such as an alcohol.

### SUMMARY

In a first embodiment, a method is described for producing a polyester polyol from a natural oil containing carbon-carbon double bonds and having an iodine value (IV) from 90 to 190 g I₂/100 g oil, the method comprising the steps of:
(a) reacting a natural oil with an alkyl mono-alcohol to produce a fatty acid alkyl esters;
(b) epoxidizing a portion of the carbon-carbon double bonds present in the fatty acid alkyl esters from step (a) to produce a partially epoxidized fatty acid alkyl esters;
(c) fully-hydrogenating the partially epoxidized fatty acid alkyl esters from step (b) to produce a hydroxylated fatty acid alkyl esters having a number average hydroxyl functionality of from 0.7 to 1.3;
(d) reacting the hydroxylated fatty acid alkyl esters from step (c) with a multifunctional ester-reactive initiator compound according to the formula

AQ-H]_{p+q}

where: A is an organic group;
(p+q) is an integer greater than or equal to 2; and
-Q-H are independently ester-reactive functional groups, such as alcohols (i.e., -Q- is —O—), amines (i.e., -Q- is

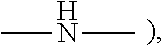

and thiols (i.e., -Q- is —S—);
to form a polyester polyol having an IV of less than 5 g I₂/100 gram polyol, a hydroxyl number from 20 mg KOH/g to 150 mg KOH/g, a number average molecular weight (Mn) from 1000 to 8000, an EOC of 0.5% or less, a viscosity at 25° C. from 0.5 Pas to 20 Pas, and a molecular weight distribution (Mw/Mn) less than 2.5.

In a second embodiment, a method is described for producing a polyester polyol from a fatty acid alkyl esters containing carbon-carbon double bonds and having an iodine value (IV) from 90 to 190 g I₂/100 g oil, the method comprising the steps of:
(a) epoxidizing a portion of the carbon-carbon double bonds present in the fatty acid alkyl esters to produce a partially epoxidized fatty acid alkyl esters;
(b) fully-hydrogenating the partially epoxidized fatty acid alkyl esters from step (a) to produce a hydroxylated fatty acid alkyl esters having a number average hydroxyl functionality of from 0.7 to 1.3; and
(c) reacting the hydroxylated fatty acid alkyl esters from step (b) with a multifunctional ester-reactive initiator compound according to the formula

AQ-H]_{p+q}

where: A is an organic group;
(p+q) is an integer greater than or equal to 2; and
-Q-H are independently ester-reactive functional groups, such as alcohols (i.e., -Q- is —O—), amines (i.e., -Q- is

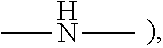

and thiols (i.e., -Q- is —S—);
to form a polyester polyol having an IV of less than 5 g I₂/100 gram polyol, a hydroxyl number from 20 mg KOH/g to 150 mg KOH/g, a number average molecular weight (Mn) from 1000 to 8000, an EOC of 0.5% or less, a viscosity at 25° C. from 0.5 Pas to 20 Pas, and a molecular weight distribution (Mw/Mn) less than 2.5.

### DETAILED DESCRIPTION

### Terms and Definitions:

As used herein “polyol” refers to a molecule having an average of greater than 1.0 hydroxyl groups per molecule. A polyol may also include functionality other than hydroxyl groups. The term polyol excludes hydroxylated fatty acid alkyl esters as described below.

“Partially-epoxidized” or “Partially-epoxidizing” refers to treating a fatty acid alkyl ester (as further described below) to modify its chemical structure to replace a portion, but less than all, of the carbon-carbon double bonds of the ester with epoxy groups. The resulting molecule is referred to as a partially-epoxidized fatty acid alkyl ester. Sufficient epoxy groups are formed to provide from 0.70 to 1.30 moles of epoxy groups per mole of partially-epoxidized fatty acid alkyl ester, preferably from 0.85 to 1.20 moles of epoxy groups per mole of partially-epoxidized fatty acid alkyl ester, more preferably from 0.90 to 1.15, and most preferably from 0.95 to 1.10 moles of epoxy groups per mole of partially-epoxidized fatty acid alkyl ester. When the fatty acid alkyl ester utilized comprises predominantly eighteen carbon (C18) chains derived from a fatty acid and the alkyl is a methyl, the epoxide oxygen content (% EOC) of the partially-epoxidized fatty acid alkyl ester typically is from 3.5% to 6.5%, preferably from 4.25% to 6%, more preferably from 4.5% to 5.75%, and most preferably from 4.75% to 5.5%. Since the epoxide oxygen content is expressed as a weight percentage, the values reported above should be increased proportionately when the fatty acids are shorter than C18, and decreased proportionately when the fatty acids are greater than C18.

“The term “fully-hydrogenating” or “fully-hydrogenated” refers to treating a partially-epoxidized fatty acid alkyl ester with hydrogen or a source of hydrogen to form a hydroxylated fatty acid alkyl ester. In fully-hydrogenating the partially-epoxidized fatty acid alkyl ester, sufficient epoxy groups should be reacted with hydrogen to obtain a percent EOC of less than 0.5, more preferably less than 0.3, and most preferably less than 0.1 in the resulting hydroxylated fatty acid alkyl ester; a number average hydroxyl functionality (Fn) of from 0.7 to 1.3, and more preferably 0.85 to 1.2, in the resulting hydroxylated fatty acid alkyl ester; and sufficient carbon-carbon double bonds should be hydrogenated to reduce the iodine value of the hydroxylated fatty acid alkyl ester to less than 5 grams I₂/100 grams ester, and preferably 4 grams I₂/100 grams ester or less.

“EOC” refers to epoxy oxygen content, which is the weight percent of epoxy oxygen for the material of interest. EOC is determined according to the procedure of ASTM D1652 (manual method—modified to use 50 ml of 5.3% solution of tetraethylammonium bromide in acetic acid). EOC is reported as percent (%).

“Iodine Value” (IV) is defined as the number of grams of iodine that will react with 100 grams of material being measured. Iodine value is a measure of the unsaturation (carbon-carbon double bonds and carbon-carbon triple bonds) present in a vegetable oil, hydroxylated fatty acid alkyl ester, or polyol. Iodine Value is reported in units of grams iodine (I₂) per 100 grams material and is determined using the procedure of AOCS Cd Id-92.

“Hydroxyl number” (OH#) is a measure of the hydroxyl (—OH) groups present in a material, such as, a hydroxylated fatty acid alkyl ester or polyol. It is reported in units of mg KOH/gram material and is measured according to the procedure of ASTM E1899-02.

“Number average molecular weight” (Mn) is determined according to the procedure delineated in the Examples and is reported in units of Daltons.

“Weight average molecular weight” (Mw) is determined according to the procedure delineated in the Examples and is reported in units of Daltons.

“Molecular weight distribution (Mw/Mn) for a particular material is determined by dividing the weight average molecular weight by the number average molecular weight.

“Acid Value” (AV) is a measure of the residual hydronium groups present in a compound and is reported in units of mg KOH/gram material. The acid number is measured according to the method of AOCS Cd 3d-63.

“Viscosity” for purposes of this invention is reported in units of pascal-seconds (Pa˜s) and is measured at 25° C. according to the procedure of ASTM D2196.

“Gardner Color Value” is a visual measure of the color of a material, such as a hydroxylated fatty acid alkyl ester and/or polyol. It is determined according to the procedure of ASTM D1544, “Standard Test Method for Color of Transparent Liquids (Gardner Color Scale).” The Gardner Color scale is defined by a series of standards ranging from colorless to dark brown, against which the sample of interest is compared. Values range from 0 for the lightest to 18 for the darkest. For the purposes of the invention, the Gardner Color Value is measured on a sample of material at room temperature.

“IFD” refers to the “indentation force deflection value” which is a measure of the load bearing quality of a foam. IFD is typically expressed in Newtons per 323 square centimeter at a given percentage deflection of the foam and measured in accordance with ASTM D3574.

“Support Factor” is Firmness at 65% IFD/Firmness at 25% IFD.

“Fn” is the number average hydroxyl functionality expressed in average number of hydroxyl groups per molecule of material, such as hydroxylated fatty acid alkyl ester or polyol. Fn is calculated using the equation:

Fn=(OH#/56)*(Mn/1000)

“Peroxide Value” is a measure of the peroxide chemical species (hydroperoxides, peroxides, etc) present in a material. It is measured according to the method of AOCS Cd 8b-90 (2003), and is reported in units of milliequivalent peroxide/1000 grams (meq/1000 grams).

“Triols” refer to polyols having a number average hydroxyl functionality of from 2.5 to 3.8.

“Diols” refer to polyols having a number average hydroxyl functionality of from 1.3 to less than 2.5.

“Biodiesel” is a generic term that commonly refers to fatty acid alkyl esters having a mixture of fatty acid groups derived from saturated fatty acids and unsaturated fatty acids. Biodiesel typically is synthesized by reacting a natural oil with an alcohol, typically methanol or ethanol, in the presence of an acid, base or neutral catalyst.

### Fatty Acid Alkyl Esters:

Starting materials that are useful for preparing the polyester polyols of the invention comprise unsaturated alkyl esters of fatty acids (hereinafter referred to as “fatty acid alkyl esters”). The fatty acid alkyl esters can be readily functionalized compared to their saturated fatty acid analogs. The fatty acid alkyl esters of the invention contain on average at least one carbon-carbon unsaturated bond within the portion of the molecule derived from a fatty acid.

The fatty acid alkyl esters typically contain carbon chain lengths in the portion derived from a fatty acid that have from 12 to 24 carbon atoms. Preferably, the majority of the portion of the fatty acid alkyl esters derived from fatty acids comprise 14 to 20 carbon atoms, more preferably comprise 16 to 18 carbon atoms, and most preferably comprise 18 carbon atoms. The alkyl group of the fatty acid alkyl esters typically comprise 1 to 6 carbon atoms (C1 to C6); preferably, C1 to C4 groups; further more preferably C1, C2, or C3 groups; even more preferably a C1 or C2 group; and most preferably a methyl (C1 group). Fatty acid alkyl esters with methyl groups are referred to as “fatty acid methyl esters”, and sometimes referred to as FAME's.

The fatty acid alkyl esters typically have an iodine value of from 90 to 220 grams I₂/100 grams of material. If a composition comprising primarily C18 fatty acid methyl or ethyl esters (i.e. the fatty acid is derived from an eighteen carbon fatty acid and the alkyl group is a methyl or ethyl) is utilized, the starting material preferably has an iodine value of from 95 to 190 grams I₂/100 grams of the material, more preferably an iodine value of from 100 to 150 gram I₂/100 grams, and most preferably 105 to 140 gram I₂/100 grams.

The starting fatty acid alkyl esters composition also may include saturated alkyl esters of fatty acids. By the term “saturated” it is meant that the portion of the ester that is derived from a fatty acid has only carbon-carbon single bonds connecting the carbon atoms without any carbon-carbon unsaturated (i.e. double or triple) bonds. Preferably, the fatty acid alkyl esters comprise less than 20 percent by weight groups derived from saturated fatty acids, more preferably less than 15 percent by weight, and further more preferably less than 10 percent by weight groups derived from saturated fatty acids. Too high levels of groups derived from saturated fatty acids will terminate the polymerization reaction resulting in polyols with less than desired hydroxyl functionality. Typically, the fatty acid alkyl esters utilized comprises from 5 to 15 percent by weight groups derived from saturated fatty acids.

The method of the invention provides a robust means to produce a hydroxylated fatty acid alkyl esters having a Fn of from 0.7 to 1.3, more preferably having a Fn of 0.85 to 1.2, more preferably having a Fn of 0.9 to 1.15, and most preferably from 0.95 to 1.10, without having to utilize starting fatty acid alkyl esters having high levels of monounsaturation. As further described below, these hydroxylated fatty acid alkyl esters can be readily polymerized to polyester polyols having a narrow molecular weight distribution. By the term “monounsaturated” it is meant that a fatty acid alkyl ester has one carbon-carbon double bond that is located in the main chain of the fatty acid ester.

Biodiesel having the iodine values and saturation levels described above is an example of a material that may be utilized as the starting material for the method of the current invention. Preferably, the biodiesel will comprise FAME's.

### Transesterifying a Natural Oil:

In many embodiments, the starting material is derived from a natural oil, such as a vegetable oil or animal fat. The natural oil typically comprises monoglycerides, diglycerides and triglycerides that result from the esterification of fatty acids onto glycerol. Generally, the triglycerides will make up the majority of the natural oil. The fatty acids typically contain carbon chain lengths in the portion derived from a fatty acid that have from 12 to 24 carbon atoms. Preferably, the portion of the oil derived from fatty acids will contain 14 to 20 carbon atoms, more preferably will contain 16 to 18 carbon atoms, and most preferably comprises 18 carbon atoms (C18).

Preferably, the natural oil is transesterified with a monofunctional alcohol, such as a C1 to C6 alcohol, preferably a C1 to C4 alcohol, further more preferably a C1, C2, or C3 alcohol, even more preferably methanol or ethanol, and most preferably methanol. The transesterification is carried out in accordance with procedures known to one of ordinary skill in the art. Exemplary descriptions of methods that can be used to transesterify a natural oil are described in Chapter 4 of The Biodiesel Handbook by Gerhard Knothe et al., AOCS Press (2005), which is incorporated by reference herein for its description of how to transesterify a natural oil. Transesterification of the triglyceride with an alcohol produces fatty acid alkyl esters. As described earlier, the esters will vary in the amount of unsaturation and the length of the main carbon chain derived from a fatty acid depending on the starting oil utilized.

The fatty acid alkyl esters typically separate from the resulting glycerol after the reaction. The reaction mixture, if necessary, is neutralized and then washed with water to extract remaining residual glycerol into the aqueous phase that readily separates from the fatty acid alkyl esters.

Useful natural oil sources include canola oil, tall oil, soybean oil, safflower oil, linseed oil, corn oil, sunflower oil, olive oil, sesame oil, cottonseed oil, rapeseed oil, tung oil, peanut oil, jatropha oil, and combinations thereof. Animal fats may also be used, for example, fish oil, lard, and tallow. The plant-based oils may be natural or genetically modified vegetable oils Also included are microbial oils, such as algal oil, including those that are genetically modified to increase yields and/or to obtain selective fatty acid distributions.

For example, to provide predominantly C18 fatty acid methyl or ethyl esters having on average at least one carbon-carbon unsaturated bond per molecule, the iodine value of the starting oil typically is from 90-190 grams I₂/100 gram oil, preferably, a natural oil having a starting iodine value of from 95-150 grams I₂/100 gram oil is utilized and more preferably a natural oil having a starting iodine value from 100-140 grams I₂/100 grams oil is utilized. These iodine values will reduce the amount of saturated fatty acid alkyl esters that are produced while also minimizing the amount of hydrogen utilized during hydrogenation of the epoxidized fatty acid alkyl esters (as further described below). As described above, after transesterification, the fatty acid alkyl esters preferably will comprise less than 20% by weight groups derived from saturated fatty acids, more preferably less than 15% by weight, and further more preferably less than 10% by weight groups derived from saturated fatty acids.

Preferably, soybean oil, corn oil, sunflower oil, and canola oil are utilized due to their relatively high iodine values and the low level of saturated fatty acids they contain. Fatty acid alkyl esters produced by the transesterification of these vegetable oils with methanol typically contain from 5 to 15 percent by weight groups derived from saturated fatty acids.

### Partial Epoxidation:

The fatty acid alkyl esters described above are partially epoxidized typically using a peroxyacid under conditions that epoxidize a portion of the carbon-carbon double bonds present within the fatty acid alkyl esters to produce partially-epoxidized fatty acid alkyl esters having from 0.7 to 1.3 moles epoxy groups per mole of partially-epoxidized fatty acid alkyl esters, preferably from 0.85 1.2 moles epoxy groups, more preferably from 0.9 to 1.15 moles of epoxy groups, and most preferably from 0.95 to 1.10 moles of epoxy groups per mole of partially-epoxidized fatty acid alkyl esters. Where the alkyl group of the ester is a methyl and the fatty acids are mostly C18, sufficient carbon-carbon double bonds are epoxidized to provide partially-epoxidized fatty acid alkyl esters having an EOC of from 3.5% to 6.5%, preferably from 4.25% to 6%, more preferably from 4.5% to 5.75%, and most preferably from 4.75% to 5.5%. Typically, another acid (in addition to peroxyacid) will be used during the epoxidation reaction.

Examples of peroxyacid that may be used include peroxyformic acid, peroxyacetic acid, trifluoroperoxyacetic acid, benzyloxyperoxyformic acid, 3,5-dinitroperoxybenzoic acid, m-chloroperoxybenzoic acid, and combinations thereof. Preferably, peroxyformic acid or peroxyacetic acid will be utilized. The peroxy acid may be added directly to the reaction, or may be formed in-situ by reacting a hydroperoxide compound with an acid such as formic acid, benzoic acid, acetic acid. Examples of typical hydroperoxides that may be utilized include hydrogen peroxide, ter-butylhydroperoxide, triphenysilylhydroperoxide, cumylhydroperoxide, and combinations thereof. Most preferably hydrogen peroxide will be used.

Preferably, the amount of acid used to form the peroxyacid is from about 0.25 to about 1.0 moles of acid per mole of carbon-carbon double bonds in the fatty acid alkyl esters that are desired to be epoxidized, and more preferably from about 0.45 to about 0.55 moles of acid per mole of carbon-carbon double bonds in the fatty acid alkyl esters that are desired to be epoxidized. Preferably, the amount of hydroperoxide used to form the peroxy acid is 1.0 to 1.5 moles of hydroperoxide per mole of double bonds in the fatty acid alkyl esters that are desired to be epoxidized, and more preferably 1.0 to 1.2 moles of hydroperoxide per mole of double bonds in the fatty acid alkyl esters that are desired to be epoxidized.

When methanol is utilized to transesterify the natural oil (i.e. the fatty acid alkyl esters are C12-C24 fatty acid methyl ester (for example, an ester formed from a C16-C18 fatty acid and methanol, commonly referred to as “FAME”)), the final EOC of the partially-epoxidized fatty acid alkyl esters is from 3.5-6.5%, preferably from 4.25-6%, more preferably from 4.5% to 5.75%, and most preferably from 4.75% to 5.5%. This relatively low EOC level will assist in providing hydroxylated fatty acid alkyl esters (as described below) having a Fri from 0.7 to 1.3, preferably from 0.85 to 1.2, more preferably from 0.9 to 1.15, and most preferably from 0.95 to 1.10. These hydroxylated fatty acid alkyl esters when polymerized as described below will result in a polyol exhibiting a relatively narrow molecular weight distribution (Mw/Mn), but with sufficient molecular weight and the desired hydroxyl content.

As discussed above, an additional acid component is typically also included in the epoxidation reaction mixture. Examples of suitable additional acid components include sulfuric acid, para-toluenesulfonic acid, hydrofluoric acid, trifluoroacetic acid, hydrofluoroboric acid, Lewis acids, acidic clays, or acidic ion exchange resins.

Optionally, a solvent may be added to the epoxidation reaction. Suitable solvents include chemically inert solvents such as aprotic solvents. For example, these solvents do not include a nucleophile, and are non-reactive with acids. Hydrophobic solvents, such as aromatic and aliphatic hydrocarbons, are especially desirable. Examples of suitable solvents include benzene, toluene, xylene, hexane, pentane, heptane, and chlorinated solvents, such as carbon tetrachloride. Solvents are useful in that they may be used to control the speed of the reaction and to reduce the number of undesirable side reactions. The solvent also reduces the viscosity of the reaction mixture and the viscosity of the mixture containing the product. This reduced viscosity aids in the processing of the partially-epoxidized fatty acid alkyl esters.

The reaction product may be neutralized to reduce any remaining acidic components in the reaction product. Suitable neutralizing agents include weak bases, metal bicarbonates, and ion-exchange resins. Examples of neutralizing agents that may be used include ammonia, calcium carbonate, sodium bicarbonate, magnesium carbonate, amines, and ion-exchange resins. An example of a suitable weakly-basic ion-exchange resin is Lewatit MP-64 ion-exchange resin (available from Bayer Corporation). Preferably, the partially-expoxidized fatty acid alkyl esters are rinsed with water to reduce the acid value to less than 1 mg KOH/gram.

### Hydrogenating the Partially-Epoxidized Fatty Acid Alkyl Ester:

The partially-epoxidized fatty acid alkyl esters are fully hydrogenated in order to both ring open the epoxy groups to form hydroxyl groups and to hydrogenate the carbon-carbon double bounds to saturated carbon-carbon bounds. In order to fully hydrogenate the partially-epoxidized fatty acid alkyl esters, sufficient hydrogenation should be conducted to: (a) obtain a number average hydroxyl functionality of from 0.7 to 1.3, preferably from 0.85 to 1.2, more preferably from 0.9 to 1.15, and most preferably from 0.95 to 1.10; (b) to reduce the iodine value of the hydroxylated fatty acid alkyl esters to less than 5 grams I₂/100 grams, preferably 4 grams I₂/100 gram or less; and (c) to reduce the EOC to 0.5 or less, and preferably less than 0.1%. Too high levels of residual carbon-carbon double bonds (unsaturation) can result in color bodies being formed in the resulting polyols of the invention and/or polymers made from the polyols.

When the alkyl group of the ester comprises a methyl group and the fatty acids are predominantly C18, the hydroxyl number of the hydroxylated fatty acid alkyl esters typically are from 120 to 230 mg KOH/gram, preferably from 140 to 210 mg KOH/gram, and most preferably 150 to 190 mg KOH/gram.

The inventors have surprisingly discovered that hydroxylated fatty acid alkyl esters, which have been hydroxylated by reaction of the epoxidized fatty acid alkyl esters with hydrogen, can be more readily polymerized (either at lower temperature and/or the reaction proceeds faster and/or is driven more readily to completion) than hydroxylated fatty acid alkyl esters that are produced by ring opening epoxidized fatty acid alkyl esters with an alcohol, such as methanol or ethanol.

Hydrogenation can be conducted according to any known method for hydrogenating carbon-carbon double bond-containing compounds such as vegetable oils. The temperature utilized during the hydrogenation reaction should be greater than the temperatures generally used to hydrogenate carbon-carbon double bonds, in order to ensure the epoxy groups are hydrogenated to hydroxyl groups during the hydrogenation. Catalysts for hydrogenation are known and can be homogeneous or heterogeneous (e.g., present in a different phase, typically the solid phase, than the substrate). One useful hydrogenation catalyst is nickel. Other useful hydrogenation catalysts include copper, palladium, platinum, molybdenum, iron, ruthenium, osmium, rhodium, iridium, zinc or cobalt. Combinations of catalysts can also be used. Bimetallic catalysts can be used, for example, palladium-copper, palladium-lead, nickel-chromite.

In some aspects, the catalysts can be impregnated on solid supports. Some useful supports include carbon, silica, alumina, magnesia, titania, and zirconia, for example. Illustrative support embodiments include, for example, palladium, platinum, rhodium or ruthenium on carbon or alumina support; nickel on magnesia, alumina or zirconia support; palladium on barium sulfate (BaSO₄) support; or copper on silica support.

Commercial examples of supported nickel hydrogenation catalysts include those available under the trade designations “NYSOFACT,” “NYSOSEL,” AND “NI 5248 D” (from Engelhard Corporation, Iselin, N.J.). Additional supported nickel hydrogenation catalysts include those commercially available under the trade designations “PRICAT 9910,” “PRICAT 9920,” “PRICAT 9908” and “PRICAT 9936” (from Johnson Matthey Catalysts, Ward Hill, Mass.).

The catalysts may be deployed in a fixed bed. The catalyst also may be finely dispersed within the partially-epoxydized fatty acid alkyl ester being hydrogenated. A system where a supported catalyst is finely dispersed within the partially-epoxydized fatty acid alkyl esters to be reacted is often referred to as a slurry phase reaction.

The metal catalysts can be utilized with promoters that may or may not be other metals. Illustrative metal catalysts with promoter include, for example, nickel with sulfur or copper as promoter; copper with chromium or zinc as promoter; zinc with chromium as promoter; and palladium on carbon with silver or bismuth as promoter.

Hydrogenation can be carried out in a batch, continuous or semi-continuous process. In a representative batch process, a vacuum is pulled on the headspace of a stirred reaction vessel and the reaction vessel is charged with the partially-epoxidized fatty acid alkyl esters to be hydrogenated (for example, partially-epoxidized FAME's). The material is then heated to a desired temperature, typically in the range of 50° C. to 300° C., for example, 75° C. to 250° C., or 100° C. to 200° C. The desired temperature can vary, for example, with hydrogen gas pressure. Typically, a higher gas pressure will require a lower temperature. In a separate container, the hydrogenation catalyst is weighed into a mixing vessel and is slurried in a small amount of the partially-epoxidized fatty acid alkyl esters to be hydrogenated. Partially-epoxidized fatty acid alkyl esters reach the desired temperature (typically a temperature below a target hydrogenation temperature), the slurry of hydrogenation catalyst is added to the reaction vessel. Hydrogen is then pumped into the reaction vessel first to flush out any air present, and then to achieve a desired pressure of H₂ gas. Typically, the H₂ gas pressure ranges from 50 psig to 2000 psig, for example, 100 psig to 1500 psig. As the gas pressure increases, more specialized high-pressure processing equipment can be required. Under these conditions the hydrogenation reaction begins and the temperature is allowed to increase to the desired hydrogenation temperature (for example, 100° C. to 200° C.), where it is maintained by cooling the reaction mass, for example, with cooling coils. When the desired degree of hydrogenation is reached, the reaction mass is cooled to the desired temperature. Typically, the desired temperature is that temperature, which is effective for filtering the mixture to remove the resulting hydroxylated fatty acid alkyl esters from particulates and residual catalyst.

After hydrogenation, the hydrogenation catalyst can be removed from the hydroxylated fatty acid alkyl esters using known techniques, for example, by filtration. In some embodiments, the hydrogenation catalyst is removed using a plate and frame filter such as those commercially available from Sparkle Filters, Inc., Conroe, Tex. In some embodiments, the filtration is performed with the assistance of pressure or a vacuum. In order to improve filtering performance, a filter aid can optionally be used. A filter aid can be added to the hydrogenated product directly or it can be applied to the filter. Representative examples of filtering aids include diatomaceous earth, silica, alumina and carbon. Other filtering techniques and filtering aids can also be employed to remove the used hydrogenation catalyst. For example, in other embodiments, the hydrogenation catalyst is removed by using centrifugation followed by decantation of the product.

In some aspects, the resulting hydroxylated fatty acid alkyl esters have a Gardner Color value of 1 or below.

### Polymerization:

After hydrogenation, the resulting hydroxylated fatty acid alkyl esters are reacted with a multifunctional ester-reactive initiator compound to form the polyester polyols of the invention. The initiator compound comprises two or more reactive groups that are capable of reacting with ester groups that are present on the hydroxylated fatty acid alkyl esters. In many embodiments, the initiator compound has the structure:

AQ-H]_{p+q}

where: A is an organic group;
(p+q) is an integer greater than or equal to 2; and
-Q-H are independently ester-reactive functional groups, such as alcohols (i.e., -Q- is —O—), amines (i.e., -Q- is

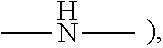

and thiol groups (i.e., -Q- is —S—).

Further, A does not contain a hydroxyl, sulfhydryl, or amine group; and preferably A does not contain other nucleophilic groups.

Exemplary multifunctional ester-reactive initiator compounds include, for example, polyamine initiators, aminoalcohols, and polyols.

Exemplary trifunctional initiator compounds (i.e. where p+q=3) include, but are not limited to: trimethylolpropane; glycerol; 1,2,6-hexanetriol; triethanolamine; diethanolamine; diethylene triamine; bis-3-aminopropyl methylamine; and any of the aforementioned where at least one of the alcohol or amine groups present therein has been reacted with ethylene oxide, propylene oxide or mixtures thereof; and combinations thereof.

Exemplary difunctional initiator compounds (i.e. where p+q=2) include, but are not limited to: 1,2-propylene glycol; 1,3-propanediol; alkanediols such as 1,6-hexanediol, 2,5-hexanediol, 1,4-butanediol, 1,4-cyclohexane diol, neopentylglycol, and ethylene glycol; and polyethylene glycols such as diethylene glycol, triethylene glycol, and tetraethylene glycol; 9(1)-hydroxymethyloctadecanol; 1,4-bishydroxymethylcyclohexane; Dimerol alcohol (36 carbon dial available from Henkel Corporation); bisphenol A; hydrogenated bisphenol; diamines, such as, ethylene diamine, neopentyldiamine, 1,6-diaminohexane, bisaminomethyltricyclodecane, bisaminocyclohexane, ethylene diamine, and neopentyldiamine; ethanolamine; and any of the aforementioned where at least one of the alcohol or amine groups present therein has been reacted with ethylene oxide, propylene oxide or mixtures thereof; and combinations thereof.

Examples of initiator compounds that may be useful for making the polyols of the invention and have greater than three functional groups include, but are not limited to, pentaerythritol, sorbitol and sucrose.

Preferably the initiator is trimethylolpropane, glycerol, an ethoxylated glycerol, propoxylated glycerol, ethoxylated trimethylolpropane, propoxylated trimethylolpropane, a glycol, polyglycol, or mixtures thereof.

More preferably, the initiator is trimethylolpropane or ethylene glycol.

In a particularly preferred aspect of the invention, the multifunctional ester-reactive initiator compound comprises glycerol that results from the transesterification of a natural oil with an alcohol, such as ethanol, methanol, and propanol; preferably methanol or ethanol; and most preferably methanol.

The desired molecular weight, functionality, and viscosity of the resulting polyol can be achieved by selecting the appropriate initiators, controlling the ratio of the initiator to hydroxylated fatty acid alkyl esters, and controlling the extent to which the reaction is allowed to progress toward completion. Typically, for ease of manufacture, the polymerization of the initiator is allowed to proceed to completion (reaction allowed to continue until little or no esters of the starting hydroxylated fatty acid alkyl esters are present in the final product).

Polyester polyols of the invention may be synthesized according to two general reaction sequences. In a first sequence, the hydroxylated fatty acid alkyl esters and the initiator are reacted with one another directly. In a second reaction sequence, the hydroxylated fatty acid alkyl esters are at least partially pre-reacted with each other prior to the initiator being added (i.e., the hydroxylated fatty acid alkyl esters arc pre-polymerized), and the resulting pre-polymerized hydroxylated fatty acid alkyl esters are then reacted with the initiator to form the polyester polyol of the invention.

The molar ratio of ester groups in the hydroxylated fatty acid alkyl esters to ester-reactive groups in the initiator typically ranges from about 1:1 (e.g., if the initiator is 1 mole of trimethylolpropane, the amount of hydroxylated fatty acid alkyl esters are 3 moles) to about 8:1.

For triols desirably having relatively longer polyester chains, the molar ratio of the hydroxylated fatty acid alkyl esters to the initiator is typically 6:1 or greater, preferably 9:1 or greater. For triols having relatively longer polyester chains, the molar ratio of ester groups in the hydroxylated fatty acid alkyl esters to the initiator typically is 24:1 or less, preferably 15:1 or less.

For diols desirably having relatively longer polyester chains, the molar ratio of the hydroxylated fatty acid alkyl esters to the initiator is typically 4:1 or greater, preferably 8:1 or greater. For diols having relatively longer polyester chains, the molar ratio of the hydroxylated fatty acid alkyl esters to the initiator typically is 24:1 or less, preferably 16:1 or less.

Typically, as the polyester chain lengths become longer, the distance between the hydroxyl groups in the polyol become longer, resulting in a reduction in the cross-linking density when the polyol is incorporated into flexible polyurethane foams, thereby providing improved flexible foam properties.

For triols and diols, if the molar ratio of ester groups in the hydroxylated fatty acid alkyl esters to ester-reactive groups in the initiator becomes too large and the reaction is carried out to completion, the resulting polyol may have an undesireably high viscosity.

Utilizing hydroxylated fatty acid alkyl esters having a Fn as described above will lead to polyester polyols having less chain branching and also leads to polyester polyols having relatively narrow molecular weight distribution (Mw/Mn). The lower molecular weight distribution will provide a more consistent polyester polyol that can be readily incorporated at high levels (above 30% of the active hydrogen containing component of a polyurethane flexible foam forming formulation), and preferably above 50% of the active hydrogen containing component, while not significantly sacrificing the foam performance. The active hydrogen containing component is often referred to as the B-Side of the polyurethane foam forming formulation.

Typically, the hydroxylated fatty acid alkyl esters and the initiator are heated to a desired reaction temperature, for a desired reaction time. In many embodiments, the reaction is conducted under vacuum and in the presence of a catalyst. Useful catalysts include, for example, tin compounds (for example, as described below), titanium compounds (for example, as described below), enzyme catalyst (e.g., lipase), carbonate catalyst (e.g., K₂CO₃, NaHCO₃), alkali metal alkoxides (e.g., NaOMe, KOMe, KO^{t}Bu) or combinations thereof. Acid catalyst may also be used, but may result in competing dehydration reactions.

The reaction temperature that is employed typically ranges from 140° C. to 300° C. when using a tin, titanium, or alkali metal-based catalyst. Preferably, the reaction temperature is at least 150° C., more preferably at least 180° C., most preferably at least 190° C. Preferably, the reaction temperature is 250° C. or less, more preferably at 220° C. or less. Enzymes usually require temperatures from room temperature up to 100° C. The reaction time typically ranges from 10 minutes to 24 hours. Preferably, the reaction time ranges from 15 minutes, more typically 30 minutes, more typically 1 hour to preferably 12 hours, more typically 9 hours and most typically 5 hours.

In many embodiments, the reaction is carried out under reduced pressure, in order to remove the alcohol (for example methanol) that results from polyester formation. Typically, the pressure is less than 100 torr, more preferably less than 50 torr, and most preferably less than 20 torr.

In one aspect, the hydroxylated fatty acid alkyl esters are placed in the reactor under reduced pressure at the reaction temperature for a period of time sufficient to polymerize a substantial amount of the hydroxylated fatty acid alkyl esters (e.g., at least 10 percent of the ester groups of the hydroxylated fatty acid alkyl esters have undergone pre-polymerization) and subsequently the initiator is added and continued for a period of time sufficient to form the polyester polyol.

For ease of manufacture, the hydroxylated fatty acid alkyl esters and initiator are added at the same time into the reactor and the polymerization is carried out, without the need to pre-polymerize the hydroxylated fatty acid alkyl esters.

Typically, when a tin catalyst is employed, the amount of catalyst is from 100 ppm to 10,000 ppm by weight of tin to the total reaction mixture. Preferably, the amount of tin catalyst is at least 250 ppm, more preferably at least 500 ppm and most preferably at least 1000 ppm to preferably less than 10,000 ppm, more preferably less than 5,000 ppm. The tin catalyst may be any suitable tin catalyst such as those known in the art. Exemplary tin catalysts include tin (II) octanoate, tin (II) 2-ethylheptanoate, dibutyl tin (IV) dilaurate, and other tin catalysts which are similarly functionalized. Preferably the tin catalyst is tin (II) octanoate, tin (II) 2-ethylheptanoate, dibutyl tin (IV) dilaurate or combination thereof.

Typically, when a titanium catalyst is employed, the amount of catalyst is from 100 ppm to 10,000 ppm by weight of titanium to the total reaction mixture. Preferably, the amount of titanium catalyst is at least 250 ppm, more preferably at least 500 ppm and most preferably at least 1000 ppm to preferably less than 10,000 ppm, more preferably less than 5,000 ppm. The titanium catalyst may be any suitable catalyst such as those known in the art. Exemplary titanium catalysts include titanium tetraisopropoxide, titanium tetraisobutoxide, or any appropriately functionalized titanium (IV) alkoxide. Preferably the titanium catalyst is titanium tetraisopropoxide.

### Properties of the Polyester Polyol:

Polyester polyols of the invention typically have a number average hydroxyl functionality (Fn) that ranges from greater than 1.3 to 3.8.

Triols polyester polyols of the invention typically have a number average hydroxyl functionality (Fn) that ranges from 2.5 to about 3.8, preferably from 2.5 to 3.5, and more preferably from 2.8 to 3.2. Triols having a Fn ranging from 2.5 to 3.5 are particularly desirable for use in flexible foam forming formulations to make polyurethane foams, such as flexible slabstock foams.

Diols polyester polyols typically have a number average functionality (Fn) from 1.3 to less than 2.5, preferably from 1.5 to less than 2.5, and more preferably from 1.8 to 2.2. Such Diols may be useful, for example, in the formulation for polyurethane (and polyester) coatings, polyurethane (and polyester) adhesives, polyurethane (and polyester) sealants, and polyurethane (and polyester) elastomers. Diols may also be used as additives in polyurethane flexible foams to improve certain properties (such as extensive properties).

The polyester polyol typically has a hydroxyl number from 20 to 150 mg KOH/grams. When the polyester polyol is a diol, the hydroxyl number preferably is from 25 to 115 mg KOH/grams and more preferably from 35 to 75 mg KOH/grams. When the polyester polyol is a triol, the hydroxyl number preferably is from 28 to 60 mg KOH/gram. For ease of use in flexible polyurethane foam forming formulations, such a triol more preferably has a hydroxyl number from 40 to 60 mg KOH/gram. Such triols are desirable because they may be used in the production of flexible polyurethane formulations where the polyester polyol can replace at least a portion of petroleum-derived triols that are typically used in such formulations. For example, in some embodiments, the polyester polyol replaces at least a portion of a petroleum-derived triol having a molecular weight of 3000 grams/mole and a hydroxyl number of 56 that is commonly used in flexible slabstock formulations.

The polyester polyol typically has a number average molecular weight from 1000 to 8000 daltons. When the polyester polyol is a triol as described above, the number average molecular weight of the polyol preferably is from 2000 to 6000 daltons and more preferably from 2500 to 4000 daltons. When the polyester polyol is a diol as described above, the number average molecular weight of the polyol preferably is from 1000 to 4000 daltons and more preferably from 1500 to 3000 daltons.

The polyester polyol typically has a iodine value of less than 5 grams I₂/100 grams polyol and preferably 4 grams I₂/100 grams polyol or less.

The polyester polyol typically has an EOC of 0.5% or less and preferably 0.1% or less.

The polyester polyol typically has a molecular weight distribution (i.e. weight average molecular weight divided by number average molecular weight (Mw/Mn)) of less than 2.5, preferably ≦2.0, more preferably ≦1.8, further more preferably ≦1.5, and in some instances ≦1.4 and sometimes ≦1.3.

The polyester polyol typically has a viscosity from 0.5 to 20 Pas, preferably less than 10.0 Pas, and in some instances, where flowability is a concern, less than 8.0 Pas, more preferably less than 6.0 Pas, and in some preferable instances, less than 4.0 Pas.

In some embodiments, the polyester polyol has a low acid value. A high acid value is undesirable, for example, if the polyol is to be used to make polyurethane foam, as the acid may neutralize the amine catalyst typically utilized causing a slowing of the foaming rate and/or requiring extra catalyst to be utilized. In some embodiments, the polyester polyol has an acid value that is less than 5 mg KOH/gram, for example, less than 4 mg KOH/gram, less than 3 mg KOH/gram, less than 2 mg KOH/gram, or less than 1 mg KOH/gram. In exemplary embodiments, the acid value is less than 1 mg KOH/gram, for example, less than 0.5 mg KOH/gram, or from 0.1 to 0.5 mg KOH/gram.

In some preferred aspects where the color of the polyol is important, the resulting polyol has a Gardner Color value of 1 or below.

In some other preferred aspects the resulting polyol contains 25 ppm or less total volatiles based on hexanal, nonanal and decanal.

In order to achieve this low volatile level, the resulting polyol may be deodorized. During the deodorizing step, the polyol is heated to a temperature of at least 170° C., preferably at least 180° C., more preferably at least 190° C. Volatiles such as hexanal, decanal, and nonanal are removed from the polyol, during and/or after the heating step. The polyol is typically heated to a sufficient temperature and for a sufficient length of time to reduce the peroxide value of the polyol to less than 10, preferably less than 8, more preferably less than 6, and in some circumstances less than 4 meg/1000 grams. Typically, the polyol will be heated to a temperature from 170° C. to 210° C. for a period of time sufficient to reduce the peroxide value to the above-described levels. Preferably, the polyol should not be heated above a temperature of 220° C., to reduce any degradation of the polyol.

In a preferred aspect, no separate deodorizing step is utilized, but a sufficiently high temperature is utilized during the polymerization (i.e. temperatures within the ranges described above for a separate deodorizing step) to deodorize the polyol during the polymerization step.

Polyester polyols of the invention that have been deodorized as described above, typically have a Peroxide Value of less than 50 meq/1000 grams, preferably less than 10 meq/1000 grams, and in some instances less than 8 meq/1000 grams, for example, less than 6 meq/1000 grams.

If desired, a nitrogen or a steam sparge may be applied toward the end of the polymerization step (or soon thereafter) and/or a separate deodorizing step, if utilized.

In another aspect the invention provides polymers (e.g., polyesters, polyurethanes, and polycarbonates) that are prepared from the polyester polyols of the invention.

In an exemplary embodiment, the polymers arc polyurethanes that comprise the reaction product of (a) a polyisocyanate; and (b) a polyester polyol of the invention.

### Polyurethane Foams:

Polyester polyols of the invention are useful in the preparation of polyurethanes, for example, flexible slabstock polyurethane foams or flexible molded polyurethane foams. In some embodiments, the polyurethane foam comprises the reaction product of: (a) a polyisocyanate; and (b) an active-hydrogen containing composition comprising a polyester polyol of the invention.

The hydroxyl groups of the polyester polyol chemically reacts with the isocyanate groups of the polyisocyanate to form urethane linkages in the resulting polyurethane foam. Thus, the polyester polyol is chemically incorporated into the polyurethane polymer.

The amount of polyester polyol included in the active hydrogen-containing composition may be selected based upon the desired performance of the foam. For example, in some embodiments, the active-hydrogen containing composition may comprise from about 10% to about 100% weight of the polyester polyol, for example, about 10% to about 60% weight polyester polyol, or about 15% to about 40% weight polyester polyol. Surprisingly, the polyester polyol of the invention can comprise relatively higher weight percentage of the active-hydrogen containing composition than typical polyols made from natural oils while still maintaining equivalent or better physical characteristics.

In some embodiments, the active-hydrogen containing composition comprises a polyester polyol and a petroleum-derived polyol. For example, in some embodiments, the active-hydrogen containing composition comprises 10% to 90% weight polyester polyol and 10% to 90% weight petroleum-derived polyol. In some embodiments, the active-hydrogen containing composition comprises 10% to 60% weight polyester polyol and 40% to 90% weight petroleum-derived polyol. In other embodiments, the active-hydrogen containing composition comprises 15% to 40% weight polyester polyol and 60% to 85% weight petroleum-derived polyol.

In some embodiments, the polyurethane foam is a flexible foam and the petroleum-derived polyol is a triol. In a specific embodiment, the petroleum-derived triol has a weight average molecular weight (Mw) of from 3000 daltons to 3500 daltons. Representative examples of commercially available petroleum-derived triols include those available under the trade designations ARCOL F3040, ARCOL F3022, and ARCOL 3222 (from Bayer), PLURACOL 1385 and PLURACOL 1388 (from BASF), VORANOL 3322, VORANOL 3010, VORANOL 3136, and VORANOL 3512A (from Dow).

In other embodiments, the polyurethane foam is a molded foam and the molecular weight of the petroleum-derived polyol ranges from from 3000 to 6000 grams/mole. Representative examples of commercially available petroleum-derived polyols for use in molded foams include VORANOL 6340 (from Dow) and MULTRANOL 3901 (from Bayer).

### Polyisocyanates:

Representative examples of useful polyisocyanates for reacting with the polyester polyols of the invention include those having an average of at least 2.0 isocyanate groups per molecule. Both aliphatic and aromatic polyisocyanates can be used. Examples of suitable aliphatic polyisocyanates include 1,4-tetramethylene diisocyanate, 1,6-hexamethylene diisocyanate, 1,12-dodecane diisocyanate, cyclobutane-1,3-diisocyanate, cyclohexane-1,3- and 1,4-diisocyanate, 1,5-diisocyanato-3,3,5-trimethylcyclohexane, hydrogenated 2,4-and/or 4,4′-diphenylmethane diisocyanate (H₁₂MDI), isophorone diisocyanate, and the like. Examples of suitable aromatic polyisocyanates include 2,4-toluene diisocyanate (TDI), 2,6-toluene diisocyanate (TDI), and blends thereof, 1,3- and 1,4-phenylene diisocyanate, 4,4′-diphenylmethane diisocyanate (including mixtures thereof with minor quantities of the 2,4′-isomer) (MDI), 1,5-naphthalene diisocyanate, triphenylmethane-4,4′,4″-triisocyanate, polyphenylpolymethylene polyisocyanates (PMDI), and the like. Derivatives and prepolymers of the foregoing polyisocyanates, such as those containing urethane, carbodiimide, allophanate, isocyanurate, acylated urea, biuret, ester, and similar groups, may be used as well.

The amount of polyisocyanate preferably is sufficient to provide an isocyanate index of from 60 to 120, preferably from 70 to 110, and, in the case of high water formulations (i.e., formulations containing at least about 5 parts by weight water per 100 parts by weight of other active hydrogen-containing materials in the formulation), from 70 to 90. As used herein the term “isocyanate index” refers to a measure of the stoichiometric balance between the equivalents of isocyanate used to the total equivalents of water, polyols and other reactants. An index of 100 means enough isocyanate is provided to react with all compounds containing active hydrogen atoms.

### Polyurethane Catalysts:

Examples of useful polyurethane catalysts include tertiary amine compounds and organometallic compounds. Specific examples of useful tertiary amine compounds include triethylenediamine, N-methylmorpholine, N-ethylmorpholine, diethyl ethanolamine, N-coco morpholine, 1-methyl-4-dimethylaminoethyl piperazine, 3-methoxy-N-dimethylpropylamine, N,N-diethyl-3-diethylaminopropylamine, dimethylbenzyl amine, bis(2-dimethylaminoethyl)ether, and the like. Tertiary amine catalysts are advantageously used in an amount from 0.01 to 5, preferably from 0.05 to 2 parts per 100 parts by weight of the active hydrogen-containing materials in the formulation.

Specific examples of useful organometallic catalysts include organic salts of metals such as tin, bismuth, iron, zinc, and the like, with the organotin catalysts being preferred. Suitable organotin catalysts include dimethyltindilaurate, dibutyltindilaurate, stannous octoate, and the like. Other suitable catalysts are taught, for example, in U.S. Pat. No. 2,846,408, which is hereby incorporated by reference. Preferably, from 0.001 to 1.0 parts by weight of an organometallic catalyst is used per 100 parts by weight of the active hydrogen-containing materials in the formulation. Blends of catalysts may also be used.

### Blowing Agents:

A blowing agent generates a gas under the conditions of the reaction between an active hydrogen compound, such as the polyester polyol of the invention, and the. polyisocyanate. Suitable blowing agents include water, liquid carbon dioxide, acetone, methylene chloride, and pentane, with water being preferred.

The blowing agent is used in an amount sufficient to provide the desired foam density and IFD. For example, when water is used as the only blowing agent, from 0.5 to 10, preferably from 1 to 8, more preferably from 2 to 6 parts by weight, are used per 100 parts by weight of other active hydrogen-containing materials in the formulation.

### Other Additives:

Other additives that may be included in the formulation include surfactants, catalysts, cell size control agents, cell opening agents, colorants, antioxidants, preservatives, static dissipative agents, plasticizers, crosslinking agents, flame retardants, and the like.

Examples of useful surfactants include silicone surfactants and the alkali metal salts of fatty acids. The silicone surfactants, e.g., block copolymers of an alkylene oxide and a dimethylsiloxane, arc preferred, with “low fog” grades of silicone surfactants being particularly preferred.

In some cases, a static dissipative agent may be included in the formulation during foam preparation, or used to treat the finished foam. Useful examples include non-volatile, ionizable metal salts, optionally in conjunction with an enhancer compound, as described in U.S. Pat. Nos. 4,806,571, 4,618,630, and 4,617,325. Of particular interest is the use of up to about 3 weight percent of sodium tetraphenylboron or a sodium salt of a perfluorinated aliphatic carboxylic acid having up to about 8 carbon atoms.

The invention will be further illustrated with reference to the following examples which are intended to aid in the understanding of the present invention, but which are not to be construed as a limitation thereof.

### EXAMPLES

Materials and Test procedures:

Refined, bleached soybean oil (RBSBO): A refined, bleached soybean oil having an iodine value of 125-135 grams I₂/100 grams oil, available from Cargill, Incorporated.

Soy FAME: Is a fatty acid methyl ester comprising 23 percent by weight groups derived from oleic acid, 53 percent by weight groups derived from linoleic acid, 8 percent by weight groups derived from linolenic acid, and 14 percent by weight groups derived from saturated fatty acids having an iodine value of 125 to 135 obtained from the transesterification of refined bleached deodorized soy bean oil with methanol.

Celite 545: is a filter aid available from EMD Sciences.

Ni Catalyst: A sponge Nickel hydrogenation catalyst in pellet form containing 20-25% by weight Nickel and 75-80% by weight tristearin available from Johnson Mathey under the designation A-5000.

FASCAT™-4350 is a butyltin compound available from Arkema, Inc.

Dowex C-211: An acidic cationic exchange resin in the form of spherical beads available from The Dow Chemical Company.

Hydrogen peroxide solution: An aqueous solution of 30% by weight H₂O₂.

Acetic Acid (99.7%): Glacial acetic acid available from EMD Sciences.

Toluene ACS 99.5% available from Alfa Aesar.

“Number average molecular weight (Mn) and weight average molecular weight (Mw)” are measured by Gel Permeation Chromatography (GPC) using a Waters High Performance Liquid Chromatography (HPLC) Pump Model #1525, a Waters 717 plus Autosampler, and a Waters 2410 Refractive Index detector (all available from Waters Corporation). The samples are eluted from PLgel columns (highly crosslinked porous polystyrene/divinylbenzene matrix) from Varian Polymer Laboratories connected in series, in the following order, two PLgel, 5 micrometer, 300×7.5 mm, 50 Angstrom (Å) columns, followed by one PLgel, 5 micrometer, 300×7.5 mm, 500 Å column. The columns are maintained at 50° C. A 10 microliter volume of a 2% solution of the sample in tetrahydrofuran (THF) is injected into the columns and eluted with THF at 1 ml/minute.

Mn and Mw are calculated using “Breeze” software available from Waters Corporation. The software calculates Mn and Mw using a second-order polynomial calibration curve based on the following standards: Soybean oil (Mn=874 Daltons), available from Cargill, Inc; Epoxidized soybean oil (Mn=94 Daltons) available from Chemtura Corporation under the trademark DRAPEX 6.8; and the following polyether polyols available from Bayer Material Science. Arcol LHT-240 (Mn=700 Daltons), Acclaim 2200 (Mn=2008 Daltons), Multranol 3400 (Mn=3000 Daltons), and Acclaim 8200 (Mn=7685 Daltons).

### Example 1

### Polyester Polyols Prepared from Fatty Acid Methyl Esters of Soybean Oil (Soy FAME)

Step A: Epoxidation of Soy FAME:

The materials indicated in Table 1 are reacted in a glass reactor (equipped with a mechanical stirrer, a thermocouple with temperature controller, a heating mantle and a dropping funnel), as indicated below. Soy FAME is epoxidized using hydrogen peroxide solution and Acetic Acid, catalyzed by Dowex C-211 in the parts by weight indicated in Table 1. The Soy FAME, toluene, Acetic Acid and Dowex C-111 are placed in the reactor, and the hydrogen peroxide is added slowly from the dropping funnel, while maintaining the temperature ˜80 C. Toluene is added in the amounts indicated in Table 1 in order to improve the miscibility between the Soy FAME and hydrogen peroxide. The reactions are carried out at 80° C. and are allowed to continue for varying times as indicated in Table 1 to obtain the desired percentages of epoxide oxygen content (EOC) in the products. The products arc then washed with water until the pH of the aqueous phase is ˜7. The epoxidized Soy FAME produced (EF-1 through EF-4), are then dried on a rotary evaporator at 90° C. under reduced pressure (final stage down to ˜4 Torr) for a few hours.

TABLE 1

| | | Soy | Hydrogen | Glacial | Dowex | | Reaction | Reaction | EOC % of |
|---|---|---|---|---|---|---|---|---|---|
| | Epoxidized | FAME | Peroxide | Acetic Acid | C-211 | Toluene | Temp | Time | product |
| Example | Soy Fame | pbw | pbw | Pbw | pbw | pbw | [C.] | [hours] | [%] |
| 1-1 | EF-1 | 100 | 32 | 8.5 | 14 | 60 | 80 | 6 | 4.06 |
| 1-2 | EF-2 | 100 | 37.78 | 10 | 16.5 | 65 | 80 | 6 | 4.71 |
| 1-3 | EF-3 | 100 | 57 | 15 | 7.5 | 43.33 | 80 | 5 | 5.11 |
| 1-4 | EF-4 | 100 | 81.33 | 20.17 | 16.33 | 51 | 80 | 5 | 6.5 |

* “pbw” refers to “parts by weight”

Step B: Hydrogenation of the Epoxidized Soy FAME:

100 parts of the epoxidized Soy FAME's (EF-1 through EF-4) from Step A are hydrogenated at 140° C. under hydrogen pressure (400 psi) in a Parr reactor, with 700 rpm stirring. The hydrogenation is carried out in 50 parts of isopropanol, and catalyzed by 10 parts of Ni Catalyst. Hydrogenation times are 3-6 hours. After hydrogenation, the catalyst is filtered under reduced pressure (vacuum) through a sintered funnel containing a layer of Celite 545 and the isopropanol is removed on a rotary evaporator at 80° C. under reduced pressure (final pressure ˜4 Torr) for a few hours. The hydroxy number of these hydroxylated Soy FAME's (HF-1 through HF-4) are reported in Table 2.

TABLE 2
Properties of hydroxylated FAME

| Hydroxylated | Hydroxy | Final | Starting | | |
|---|---|---|---|---|---|
| FAME | Value | EOC % | Epoxidized | IV of HF's | Fn of |
| ID | (mgKOH/g) | (%) | Soy Fame | gm I₂/100 g | HF's |
| HF-1 | 126.35 | 0.06 | EF-1 | <5 | 0.71 |
| HF-2 | 146.02 | 0.04 | EF-2 | <5 | 0.82 |
| HF-3 | 154.44 | 0.09 | EF-3 | <5 | 0.86 |
| HF-4 | 195.91 | 0.07 | EF-4 | <5 | 1.10 |

Step C: Polymerization of Hydroxylated Soy FAME:

The polymerizations are carried out at 220° C., in a glass reactor, equipped with a magnetic stirrer, a heating mantle, a thermocouple and heating controller. A condenser is attached to the flask with a flask to collect the methanol that is distilled over. The reactions are catalyzed by 0.5 wt % of Fascat-4350. The initial stages of the polymerization is carried out at 220° C. for 2 hours at atmospheric pressure, followed by 220° C. under reduced pressure for 1 hour and 30 minutes. The final pressure drops down to ˜3 mm Hg. The molar ratios of hydroxylated FAME to multifunctional ester-reactive initiator (trimethylolpropane (TMP)) and the amount of catalyst (Fascat 4350) are indicated in Table 3. The properties of the resulting polyols are listed in Table 4.

TABLE 3
Polymerization reaction

| Hydroxylated | | | Molar Ratio: | Resulting |
|---|---|---|---|---|
| FAME 100 parts | TMP | Fascat 4350 | Hydroxylated | Polyester |
| by weight | [parts] | [parts] | FAME to Initiator | Polyol |
| HF-1 | 6.17 | 0.53 | 7:1 | PP-1 |
| HF-2 | 6.17 | 0.53 | 7:1 | PP-2 |
| HF-3 | 6.18 | 0.53 | 7:1 | PP-3 |
| HF-4 | 6.18 | 0.53 | 7:1 | PP-4 |

TABLE 4
Properties of polyester polyols

| Sample | OH# | AV | | | | | Viscosity | |
|---|---|---|---|---|---|---|---|---|
| ID | [mgKOH/g] | [mgKOH/g] | Mn | Mw | Fn | Fw | [Pa · s] | Mw/Mn |
| PP-1 | 24.93 | 0.55 | 1927 | 2524 | 0.86 | 1.12 | 0.968 | 1.31 |
| PP-2 | 41.36 | 0.55 | 2103 | 2839 | 1.55 | 2.1 | 1.402 | 1.35 |
| PP-3 | 56.38 | 0.5 | 2019 | 2766 | 2.03 | 2.79 | 1.603 | 1.37 |
| PP-4 | 108.16 | 0.53 | 1951 | 2848 | 3.76 | 5.49 | 3.838 | 1.46 |

As can be seen from Table 4, the polyester polyols of the invention are very homogeneous in their structure, as exemplified by their relatively narrow molecular weight distribution. All the polyester polyols exhibit a molecular weight distribution of less than 2.5, in fact all the polyester polyols of Table 4 exhibit a molecular weight distribution of less than 1.8, and several exhibit an Mw/Mn less than 1.5, even less than 1.4. The Fn of PP-1 was lower than expected. It is believed this lower than theoretical Fn was the result of side reactions during hydrogenation and polymerization.

1. A method for producing a polyester polyol from a natural oil containing carbon-carbon double bonds and having an iodine value (IV) from 90 to 190 g I2/100 g oil, the method comprising the steps of:
(a) reacting a natural oil with an alkyl mono-alcohol to produce a fatty acid alkyl esters;
(b) epoxidizing a portion of the carbon-carbon double bonds present in the fatty acid alkyl esters from step (a) to produce a partially epoxidized fatty acid alkyl esters;
(c) fully-hydrogenating the partially epoxidized fatty acid alkyl esters from step (b) to produce a hydroxylated fatty acid alkyl esters having a number average hydroxyl functionality of from 0.7 to 1.3;
(d) reacting the hydroxylated fatty acid alkyl esters from step (c) with a multifunctional ester-reactive initiator compound according to the formula
where: A is an organic group;
(p+q) is an integer greater than or equal to 2; and
-Q-H are independently ester-reactive functional groups, such as alcohols (i.e., -Q- is —O—), amines (i.e., -Q- is), and thiols (i.e., -Q- is —S—);
to form a polyester polyol having an IV of less than 5 g I2/100 gram polyol, a hydroxyl number from 20 mg KOH/g to 150 mg KOH/g, a number average molecular weight (Mn) from 1000 to 8000, an EOC of 0.5% or less, a viscosity at 250 C from 0.5 Pas to 20 Pas, and a molecular weight distribution (Mw/Mn) less than 2.5.

2. The method of claim 1, wherein p+q is 3 and the polyester polyol having: (1) a hydroxyl number of from 28 to 60 mg KOH/gram, and (2) a number average molecular weight of from 2000 to 6000, and a molecular weight distribution (Mw/Mn)≦2.0.

3. The method of claim 1, wherein the polyester polyol comprises a triol having a hydroxyl number of from 40 to 60 mg KOH/gram, a number average molecular weight of from 2500 to 4000, a viscosity at 250 C of less than 8 Pas, an iodine value less than 4 g I2/100 gram, and a molecular weight distribution (Mw/Mn)≦1.8.

4. The method claim 1, wherein the multifunctional ester-reactive initiator compound is selected from the group consisting of: trimethylolpropane, glycerol, pentaerythritol, ethylene glycol, propylene glycol, polyethyleneglycols, alkanediols, monoethanolamine, diethanolamine, triethanolamine, ethylene diamine, diethylenetriamine, and their alkoxylated derivatives.

5. The method of claim 1, wherein p+q is 2 and the polyester polyol has: (1) a hydroxyl number of from 25 to 115 mg KOH/gram, (2) a number average molecular weight of from 1000 to 4000, and (3) a viscosity at 250 C of from 0.5 Pas to 8 Pas, and (4) a molecular weight distribution (Mw/Mn) less than 2.5.

6. The method of claim 1, wherein the polyester polyol comprises a diol having a hydroxyl number of from 35 to 75 mg KOH/gram, a number average molecular weight of from 1500 to 3000, an iodine value of than 4 g I2/100 gram or less, and a molecular weight distribution (Mw/Mn)≦2.0.

7. The method of claim 1, wherein the epoxidation of step (b) is carried out in a reaction vessel containing the fatty acid alkyl ester from step (a) and the epoxidation step comprises:
(b1) introducing an organic acid and a peroxy-compound into the reaction vessel; and
(b2) providing sufficient heat to initiate a reaction; and
(b3) continuing the reaction to produce a partially epoxidized fatty acid alkyl esters having from 0.7 to 1.3 moles of epoxy groups per mole of epoxidized fatty acid alkyl esters.

8. The method of claim 7, wherein the fatty acid alkyl esters comprises C18 fatty acid methyl esters and wherein the partially epoxidized fatty acid alkyl esters have an EOC of from 3.5 to 6.5 percent by weight.

9. The method of claim 1, wherein the hydrogenation step (c) is carried out until the hydroxylated fatty acid alkyl esters have an iodine value of 4 g I2/100 gram or less.

10. The method of claim 1, wherein the hydrogenation step (c) is carried out using a catalyst selected from the group consisting of: a nickel containing catalyst, a platinum containing catalyst, a nickel-platinum containing catalyst and other noble metal containing catalysts.

11. The method of claim 1, wherein reaction of step (a) results in a mixture comprising fatty acid alkyl esters and glycerol and the method further comprises (a1) treating the mixture to produce a fatty acid alkyl esters enriched fraction that is epoxidized in step (b).

12. The method of claim 1, wherein the reaction of step (a) results in a mixture comprising a fatty acid alkyl esters and glycerol and wherein the multifunctional ester-reactive initiator compound comprises the glycerol resulting from step (a).

13. The method of claim 11, wherein treating step (a1) comprises washing the mixture with water to extract glycerol.

14. The method of claim 1, wherein a molar ratio of hydroxylated fatty acid alkyl esters to multifunctional ester-reactive initiator compound is from 4:1 to 24:1.

15. The method of claim 2, wherein a molar ratio of hydroxylated fatty acid alkyl esters to multifunctional ester-reactive initiator compound is from 6:1 to 24:1.

16. The method of claim 5, wherein a ratio of hydroxylated fatty acid alkyl esters to multifunctional ester-reactive initiator compound is from 4:1 to 24:1.

17. A method for producing a polyester polyol from a fatty acid alkyl esters containing carbon-carbon double bonds and having an iodine value (IV) from 90 to 190 g I2/100 g oil, the method comprising the steps of:
(a) epoxidizing a portion of the carbon-carbon double bonds present in the fatty acid alkyl esters to produce a partially epoxidized fatty acid alkyl esters;
(b) fully-hydrogenating the partially epoxidized fatty acid alkyl esters from step (a) to produce a hydroxylated fatty acid alkyl esters having a number average hydroxyl functionality of from 0.7 to 1.3; and
(c) reacting the hydroxylated fatty acid alkyl esters from step (b) with a multifunctional ester-reactive initiator compound according to the formula
where: A is an organic group;
(p+q) is an integer greater than or equal to 2; and
-Q-H are independently ester-reactive functional groups, such as alcohols (i.e., -Q- is —O—), amines (i.e., -Q- is), and thiols (i.e., -Q- is —S—);
to form a polyester polyol having an IV of less than 5 g I2/100 gram polyol, a hydroxyl number from 20 mg KOH/g to 150 mg KOH/g, a number average molecular weight (Mn) from 1000 to 8000, an EOC of 0.5% or less, a viscosity at 250 C from 0.5 Pas to 20 Pas, and a molecular weight distribution (Mw/Mn) less than 2.5.

18. The method of claim 17, wherein the fatty acid alkyl esters comprises a fatty acid methyl ester having a iodine value of from 105 to 140 gram I2/100 grams.

19. The method of claim 17, wherein the hydroxylated fatty acid alkyl esters have a number average hydroxyl functionality of from 0.85 to 1.2.

20. The method of claim 17, wherein the polyester polyol has a molecular weight distribution of ≦1.8.

21. The method of claim 1, wherein p+q is 3 and the polyester polyol has: (1) a hydroxyl number of from 28 to 60 mg KOH/gram, and (2) a number average molecular weight of from 2000 to 6000, and a molecular weight distribution (Mw/Mn)≦2.0.

22. The method of claim 17, wherein the polyester polyol comprises a triol having a hydroxyl number of from 40 to 60 mg KOH/gram, a number average molecular weight of from 2500 to 4000, a viscosity at 250 C of less than 8 Pas, an iodine value less than 4 g I2/100 grams, and a molecular weight distribution (Mw/Mn)≦1.8.

23. The method of claim 17, wherein the multifunctional ester-reactive initiator compound is selected from the group consisting of: trimethylolpropane, glycerol, pentaerythritol, ethylene glycol, propylene glycol, various polyethyleneglycols, alkanediols, monoethanolamine, diethanolamine, triethanolamine, ethylene diamine, diethylenetriamine, and their alkoxylated derivatives.

24. The method of claim 17 wherein p+q is 2 and the polyester polyol has: (1) a hydroxyl number of from 25 to 115 mg KOH/gram, (2) a number average molecular weight of from 1000 to 4000, and (3) a viscosity at 250 C of from 0.5 Pas to 8 Pas, and (4) a molecular weight distribution (Mw/Mn) less than 2.5.

25. The method of claim 17, wherein the polyester polyol comprises a diol having a hydroxyl number of from 35 to 75 mg KOH/gram, a number average molecular weight of from 1500 to 3000, an iodine value of than 4 g I2/100 gram or less, and a molecular weight distribution (Mw/Mn)≦2.0.

26. The method of claim 17, wherein the epoxidation of step (a) is carried out in a reaction vessel containing the fatty acid alkyl esters and the epoxidation step comprises:
(a1) introducing an organic acid and a peroxy-compound into the reaction vessel; and
(a2) providing sufficient heat to initiate a reaction; and
(a3) continuing the reaction to produce a partially epoxidized fatty acid alkyl esters having from 0.7 to 1.3 moles of epoxy groups per mole of epoxidized fatty acid alkyl esters.

27. The method of claim 26, wherein the fatty acid alkyl ester comprises C18 fatty acid methyl esters and wherein the partially epoxidized fatty acid alkyl esters have an EOC of from 3.5 to 6.5 percent by weight.

28. The method of claim 17, wherein a molar ratio of hydroxylated fatty acid alkyl esters to multifunctional ester-reactive initiator compound is from 4:1 to 24:1.

29. The method of claim 21, wherein a molar ratio of hydroxylated fatty acid alkyl esters to multifunctional ester-reactive initiator compound is from 6:1 to 24:1.

30. The method of claim 24, wherein a ratio of hydroxylated fatty acid alkyl esters to multifunctional ester-reactive initiator compound is from 4:1 to 24:1.

31. The method of claim 1, wherein A does not contain a hydroxyl, sulfhydryl, or amine group.

32. The method of claim 1, wherein A does not contain a nucleophilic group.
